(19) United States
(12) Patent Application Publication
(10) Pub. No.: US 2006/0223428 A1
(43) Pub. Date: Oct. 5, 2006

(54) Game media payout device for use in a game machine

(75) Inventor: Hideaki Fujii, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Aruze Corp., Tokyo (JP)

(21) Appl. No.: 11/378,858

(22) Filed: Mar. 17, 2006

(30) Foreign Application Priority Data
May 20, 2004 (JP) 2004-150425

(51) Int. Cl. G07D 1/00

(52) U.S. Cl. 453/57

(57) ABSTRACT

A game media payout device for use in a game machine includes a rotary disc disposed on a bottom of a container; a payout control means for generating a payout instruction signal for paying out a predetermined number of game media; a driving means for driving the rotary disc in a clockwise direction in response to the payout instruction signal and driving the rotary disc in a counterclockwise direction if a predetermined condition is satisfied; a detecting means installed at a game media outlet, for detecting the game media being ejected to the game media outlet by the displaceable roller; and a monitoring means for monitoring an operation of the detecting means even in a situation where the driving means drives the rotation of the rotary disc in a counterclockwise direction in response to the payout instruction signal.

### CROSS REFERENCE TO RELATED APPLICATION

This application is related to the prior Japanese Patent Application No. 2004-150425, filed in Japan on May 20, 2004, the entire contents of which are incorporated herein by reference.

### FIELD OF THE INVENTION

The present invention relates to a game media payout device for use in a game machine such as a slot machine for performing a game using game media such as coins, medals and tokens (hereinafter, referred to as “coins”).

### BACKGROUND OF THE INVENTION

For example, a game media payout device for use in a “Pachinko” type slot machine (“Pachinko slot machine”) typically includes a container (bucket) for accommodating a plurality of game media, a rotary disc having thereon a plurality of game media holes, each of which can accommodates a game medium dropping from the container, a motor for driving the rotation of the rotary disc, and a sensor for sensing the discharging of a game media ejected from the rotary disc being rotated by the motor.

In a Pachinko slot machine, a game is played in such a way that a plurality of reels, each having a plurality of symbols illustrated thereon are rotated, and each of the plurality of reels being rotated is stopped sequentially according to a player's control for stopping the reels. Further, if a combination of symbols on the reels displayed in a certain area of a display window corresponds to a winning combination, it is determined how much the player is paid out for the combination.

Japanese Laid-open Publication No. H7-85333 discloses a game media payout device for use in a Pachinko slot machine, wherein game media accommodated in a container are easily and smoothly dropped into and caught in the openings of a rotary disc installed in an ejecting part of the machine, and game media are prevented from being caught between game media already caught in the openings and the walls of the openings such that the rotary disc can be rotated without interruption, thereby improving its reliability and ejecting efficiency.

However, in such a game media payout device as described above, a means for detecting more precisely the number of game media being paid out is needed for a better management of game media in an arcade.

### SUMMARY OF THE INVENTION

It is, therefore, an object of the present invention to provide a game media payout device for use in a game machine for detecting more precisely the number of game media being paid out.

The present invention has been conceived to achieve the above-mentioned object; and, particularly, provides a game media payout device as follows.

In accordance with a preferred embodiment of the present invention, there is provided a game media payout device for use in a game machine, including: a container for accommodating a multiplicity of game media (e.g., a bucket 115 to be described later), a rotary disc disposed on a bottom of the container (e.g., a rotary disc 111 to be described later), a plurality of openings (e.g., circular openings 125 to be described later) arranged in a circumference of the rotary disc, each of the openings having a size for accommodating a game medium, a payout control means (e.g., a main control circuit 71 and a CPU 31 to be described later) for generating a payout instruction signal for paying out a predetermined number of game media, a driving means (e.g., a hopper driving circuit 41 and a motor 121 to be described later), which is configured to drive the rotary disc in a clockwise direction or a counterclockwise direction, for driving the rotary disc in a clockwise direction in response to the payout instruction signal and driving the rotary disc in a counterclockwise direction if a predetermined condition is satisfied, a game media receiving plate (e.g., a supporting plate 120) for receiving game media dropped from the container and caught in the openings, a game media feeding guide plate (e.g., a coin-feeding guide plate 130 to be described later), which is installed to be integrated into a rear surface of the rotary disc, for guiding the game media received by the game media receiving plate in a direction radially away from the center of the rotary disc in response to the rotation of the rotary disc in a clockwise direction, a fixed roller (e.g., a fixed roller 123 to be described later) disposed at a game media outlet, for changing a moving direction of the game media toward the game media outlet, a displaceable roller (e.g., a displaceable roller 124 to be described later) disposed at a the game media outlet, which is displaced by the movements of the game media being ejected by the game media feeding guide plate to eject the game media to the game media outlet, a detecting means (e.g., coin detecting units 40Sa and 40Sb) disposed at the game media outlet, for detecting the game media being ejected to the game media outlet by the displaceable roller, a monitoring means (e.g., a main control circuit 71 and a CPU 31 to be described later) for monitoring an operation of the detecting means (e.g., monitoring an operation of a coin-passing switch and whether a coin detecting signal is outputted or not, which will be described later) even in a situation where the driving means drives the rotation of the rotary disc in a counterclockwise direction in response to the payout instruction signal.

In the game media payout device in accordance with the preferred embodiment of the present invention, the monitoring means monitors an operation of the detecting means even in a situation where the driving means drives the rotary disc in a counterclockwise direction in response to the payout instruction signal. Therefore, it is possible to monitor more precisely a payout of game media.

Further, in the game media payout device for use in a game machine, the predetermined condition is satisfied at least by either: the case (e.g., an occurrence of an empty error to be described later) where the detecting means does not detect any game media being payout even if the driving means drives the rotary disc in a clockwise direction during predetermined time (e.g., time for determining an empty error to be described later); or the case (e.g., an occurrence of a jam error to be described later) where the detecting means detects continuously game media being paid out during a predetermined time (e.g., time for determining a jam error to be described later) after a payout instruction signal is generated.

In the game media payout device for use in a game machine, for instance, even in case a jam error or an empty error occurs, it is possible to monitor more precisely the payout of game media.

### BRIEF DESCRIPTION OF THE DRAWINGS

The above and other objects and features in accordance with the present invention will become apparent from the following descriptions of preferred embodiments given in conjunction with the accompanying drawings, in which:

FIG. 1 shows a perspective view of an external appearance of a game machine in accordance with the present invention;

FIG. 2 illustrates a configuration of various devices installed inside a game machine in accordance with the present invention;

FIG. 3 depicts a perspective view of an external appearance of a hopper for use in a game machine in accordance with the present invention;

FIG. 4 describes disassembled main parts of a hopper for use in a game machine in accordance with the present invention;

FIG. 5 presents movements of coins being payout in a game machine in accordance with the present invention;

FIG. 6 sets forth a cross-sectional view of a first outlet in accordance with the present invention;

FIG. 7 sets forth another cross-sectional view of the first outlet in accordance with the present invention;

FIG. 8 is a block diagram showing a configuration of electric circuits installed in a game machine in accordance with the present invention;

FIG. 9 describes a time chart showing driving directions of a motor in accordance with the present invention;

FIGS. 10 to 12 illustrate a flowchart showing an operation of a main control circuit of a game machine in accordance with the present invention;

FIG. 13 presents a flowchart showing a method for processing of a periodic interrupt;

FIG. 14 sets forth a flowchart showing a method for processing a payout of coins;

FIG. 15 describes a flowchart showing a method for checking a payout of coins;

FIG. 16 illustrates a flowchart showing a method for checking errors; and

FIG. 17 presents a flowchart showing a method for processing errors.

### DETAILED DESCRIPTION OF THE PRESENT INVENTION

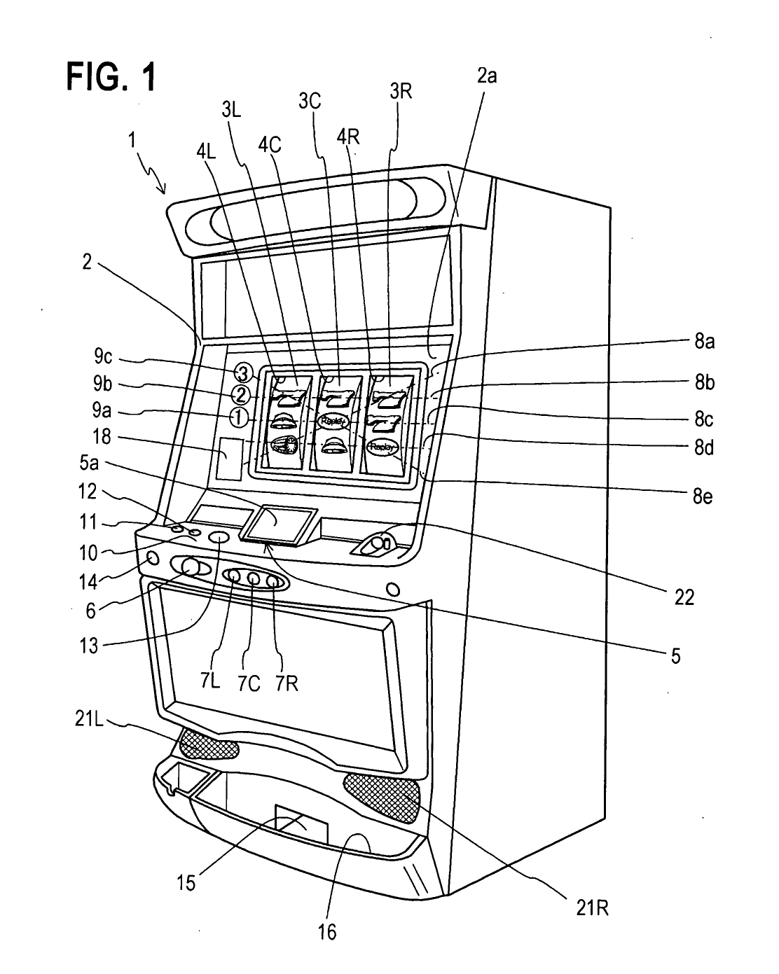

FIG. 1 shows a perspective view of an external appearance of a game machine 1 in accordance with a preferred embodiment of the present invention. The game machine 1 is a so-called Pachinko slot machine. A player plays a game using the game machine 1 by inserting therein coins, medals, game balls or tokens as well as a card for recording therein information on credits for the game. Hereinafter, the operation of the game machine 1 will be explained assuming the use of “coins”, which means the use of medals, coins and tokens.

On a front surface of a cabinet of the game machine 1, there is installed a main door 2. A panel display unit 2a is formed on a front surface of the main door 2. Further, on a center portion of the panel display unit 2a, there are installed display windows 4L, 4C and 4R, each having a shape of a vertical rectangle. The display windows 4L, 4C and 4R may display pay lines such as a top line 8b, a center line 8c and a final result line 8d in a horizontal direction, and a cross-up line 8a and a cross-down line 8e in a slanted direction.

One, three or five lines among the pay lines may be activated as a result of operating an 1-BET switch 11, a 2-BET switch 12 and a maximum BET switch 13, or inserting coins into a coin insertion slot 22, which will be described later. A player is noted by lighting BET lamps 9a to 9c to be described later which of the pay lines is activated.

In a rear side of the main door 2, there are installed three rotatable reels 3L, 3C and 3R in a row, on each of circumference surfaces of which a series of plural symbols are illustrated. The symbols illustrated on each of the reels are observed through the display windows 4L, 4C and 4R. Further, each of the reels is installed to rotate in a predetermined speed (e.g., 80 rpm).

On a left side of the display windows 4L, 4C and 4R, there are disposed an 1-BET lamp 9a, a 2-BET lamp 9b, a maximum BET lamp 9c and an information display unit 18. The 1-BET lamp 9a, the 2-BET lamp 9b and the maximum BET lamp 9c are lighted differently depending on the number of coins bet for a game (hereinafter referred to as “the number of BETs”).

In particular, the 1-BET lamp 9a is lighted when the number of BETs is “1” and one pay line is activated; the 2-BET lamp 9b is lighted when the number of BETs is “2 and three pay lines are activated; and the maximum BET lamp 9c is lighted when the number of BETs is “3” and all of the five pay lines are activated. The information display unit 18 includes a seven-segmented LED, which displays the number of deposited (credited) coins or the number of coins to be payout when a player wins a game.

A control panel 10 having a horizontal surface is formed under the display windows 4L, 4C and 4R. Also, an LCD display device 5 is positioned between the control panel 10 and the display windows 4L, 4C and 4R. A display screen 5a of the LCD display device 5 displays information on a game. A coin insertion slot 22 is installed on a right side of the LCD display device 5; and an 1-BET switch 11, a 2-BET switch 12 and a maximum BET switch 13 are installed on a left side of the LCD display device 5.

By pushing once the 1-BET switch 11, the 2-BET switch 12 and the maximum BET switch 13, respectively, one, two and all of deposited coins are bet for a game. As mentioned above, by manipulating these BET switches, predetermined pay lines are activated.

Under the LCD display device 5 of the control panel 10, there are installed three stop buttons 7L, 7C and 7R for stopping the rotation of the reels 3L, 3C and 3R, respectively. On a left side of the stop buttons 7L, 7C and 7R, a start lever 6 is installed to rotate within a predetermined angle, such that a player can manipulate it to display various symbols in the display windows 4L, 4C and 4R.

Meanwhile, on upper left and right sides of a coin tray 16, there are installed loud speakers 21L and 21R. In the embodiment of the present invention, a single game is started by manipulating the start lever 6 and is completed when all of the reels 3L, 3C and 3R are stopped.

On a left portion of the control panel 10, a C/P switch 14 is installed to determine whether coins obtained by a player is credited or paid out. That is, by manipulating the C/P switch 14, a credit mode (ON/OFF) of a game is determined. The credit mode means an internal status of the game machine 1 for indicating whether to deposit coins inserted into the game machine 1 and coins to be paid out as a winning for a game.

If the credit mode is turned ON, coins inserted into the coin insertion slot 22 and coins to be paid out according to a wining combination are credited. The number of the credited coins is displayed on the information display unit 18. On the other hand, if the credit mode is turned OFF, the deposited coins are payout through a coin payout outlet 15 from a hopper 40, which are then stored in a coin tray 16 installed in a lower part of the game machine 1.

As mentioned above, if the credit mode is turned OFF, a number of coins corresponding to a winning combination are paid out through the coin payout outlet 15 from the hopper 40. In the game machine 1 in accordance with the embodiment of the present invention, the maximum number of creditable coins is 50 and, therefore, any coins over the maximum number of creditable coins are paid out through the coin payout outlet 15 from the hopper 40. For example, in case 49 coins are already credited and a wining combination corresponding to a payout of 15 coins is registered, one of the 15 coins is credited and the remaining 14 coins are payout through the coin payout outlet 15 from the hopper 40.

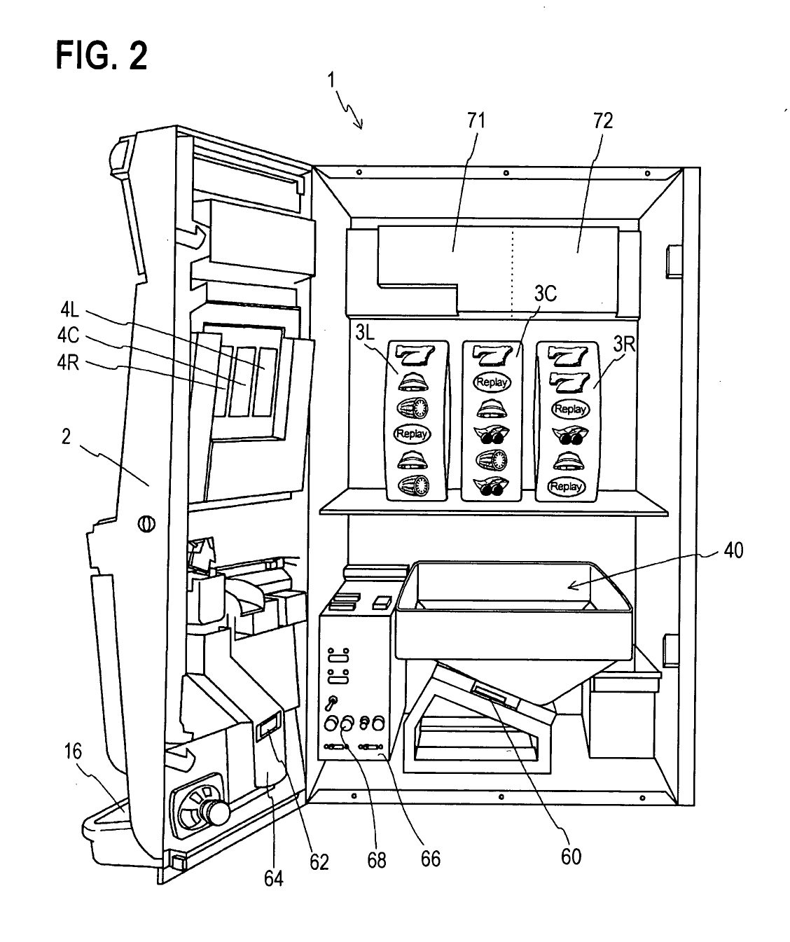

FIG. 2 illustrates a configuration of various devices installed inside the game machine 1 in accordance with the preferred embodiment of the present invention.

In an upper portion inside the game machine 1, a control unit for electrically controlling the game machine 1 is installed, which includes a main control circuit 71 and a sub-control circuit 72. Further, under the control unit, a series of the reels 3L, 3C and 3R are installed rotatably, on each of circumference surfaces of which a row of symbols is illustrated. Under the reels 3L, 3C and 3R, there is installed a hopper 40 for depositing and paying out coins.

On a front surface of the hopper 40, a first outlet 60 is formed to constitute a coin discharging unit, through which coins deposited in the hopper are ejected. In a rear side of the main door 2, a second outlet 62 is formed to accommodate coins ejected from the first outlet 60. The coins ejected from the first outlet 60 are accommodated by the second outlet 62, which are then paid out from the coin payout outlet 15 into the coin tray 16 through a shoot 64.

In a left side of the hopper 40, there is installed a power source box 66. The power source box 66 includes various switches such an error reset switch 68. The error reset switch 68 is used to restart a payout of coins in the hopper 40 after some problems (a payout error) related to a payout of coins in the hopper 40 are solved (e.g., in case coins filled therein is removed or new coins are refilled therein).

The problems related to a payout of coins include a hopper jam error (hereinafter referred to as a “jam error”) and a hopper empty error (hereinafter referred to as an “empty error”). The jam error indicates a situation where coins deposited in the hopper 40 cannot be paid out. The empty error indicates a situation where any coins are not deposited in the hopper 40.

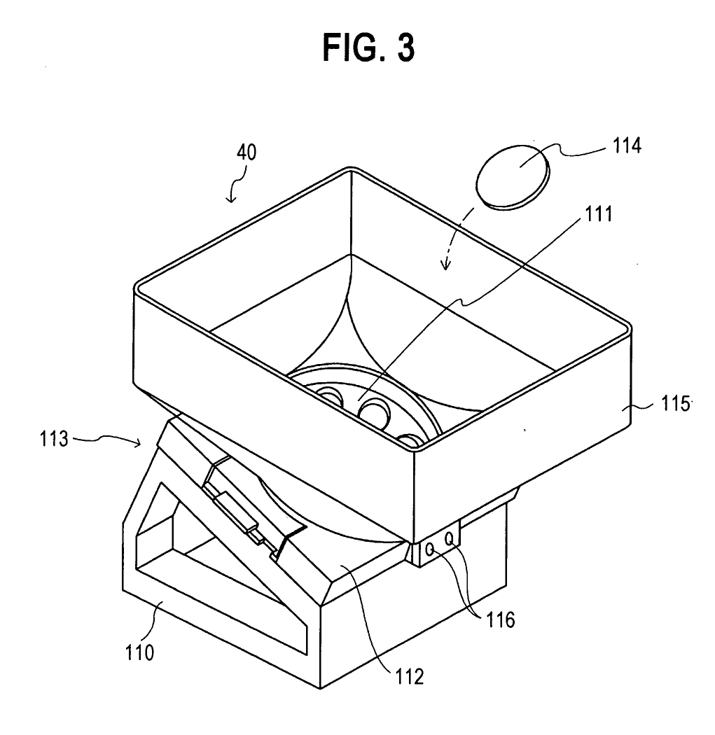

In the following, a configuration of the hopper 40 will be described in detail with reference to FIGS. 3 to 7.

FIG. 3 illustrates a perspective view of an external appearance of the hopper 40. As shown in FIG. 3, the hopper 40 includes a main body unit 113 including of a base 110, a rotary disc 111 and a cover 112; and a container 115 (hereinafter referred to as a “bucket”) for accommodating therein a large amount of coins. The bucket 115 is attached to the main body unit 113 through attaching screws 116, and can be readily detached from the main body unit 113. In the drawing, the reference number 114 indicates a coin.

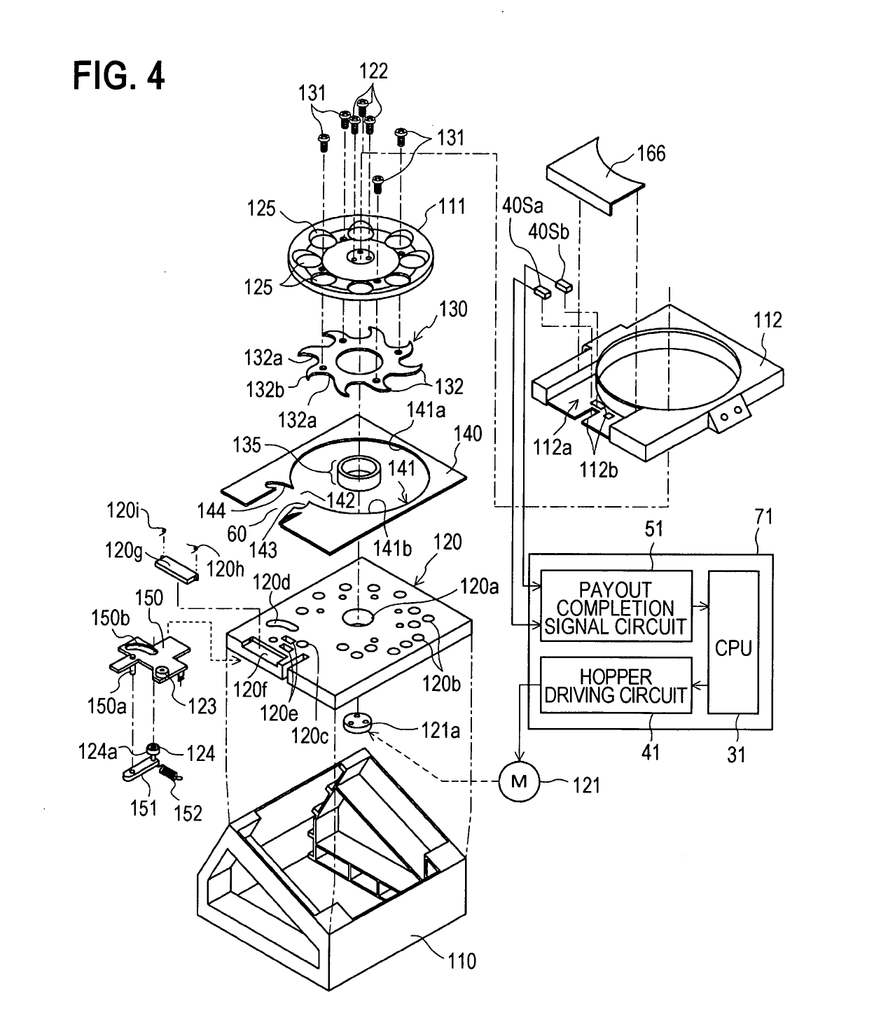

FIG. 4 shows the main body unit 113 of the hopper 40, which is disassembled in a state of the cover 112 being detached therefrom. The base 110 consists of a frame, a top surface of which is slanted, e.g., at an angle of 25 degrees. A supporting plate 120 made of a rectangular metal plate is attached on the top surface of the base 110. A motor 121 having a deceleration device is attached on a bottom of the supporting plate 120.

A head 121a is fixed to an output axis of the deceleration device. The head 121a is aligned into an axis hole 120a formed in the supporting plate 120. One end of the head 121a is fixed to the rotary disc 111 through attaching screws 122. On a coin-receiving surface of the supporting plate 120, there are formed holes 120b for discharging dust, a hole 120c through which a fixed roller 123 is protruded, a hold 120d for guiding a displaceable roller 124, sensor windows 120e for coin sensors, and a stepped portion 120f in which a screening member 120g is positioned.

The screening member 120g is attached rotatably to two sidewalls of the stepped portion 120f (i.e., two axis of the screening member 120g are attached rotatably to two holes formed on the sidewalls of the stepped portion 120f). One end of each of torsion springs 120i and 120h (so-called Kamome springs) is engaged on a rear side of the screening member 120g, and the screening member 120g is kept being protruded from the top surface of the supporting plate 120.

On the rotary disc 111, eight circular openings 125, each having a diameter slightly larger than that of a coin are formed at equal intervals in a circumferential direction thereof. The number of the circular openings 125 may be changed depending on a size of the rotary disc 111. An inner circumference of the circular openings 125 becomes gradually wider going from a lower portion to an upper portion thereof, such that coins can easily drop and slide into the circular openings 125.

Under the rotary disc 111, there is disposed a thrust bearing 135. The thrust bearing 135 is fixed into a groove formed on a rear side of the rotary disc 111, which is disposed between the rotary disc 111 and the supporting plate 120. The thrust bearing 135 supports a load of coins accommodated in the bucket 115, whereby the rotary disc 111 can be rotated smoothly under the bucket 115.

A coin-feeding guide plate 130 is attached to a bottom of the rotary disc 111 through attaching screws 131. The coin-feeding guide plate 130 is made of metal in a shape of a ratchet wheel that has eight guide pawls 132, the number of which corresponds to that of the openings 125 of the rotary disc 111. Each of the guide pawls 132 has a coin-holding guide surface 132a and a coin-feeding guide surface 132b at inner and outer edges thereof, respectively.

The coin-holding guide surface 132a is formed in a shape of an arc corresponding to a shape of each of the circular openings 125. The coin-feeding guide surface 132b is connected to an inner end of the coin-holding guide surface 132a and connected to an outer end of the coin-holding guide surface 132a at an acute angle, which forms a shape of an externally extended arc. Therefore, coins are dropped into the supporting plate 120 through the circular openings 125 and held by the coin-holding guide surface 132a. Then, the coins are guided radially away from the center of the rotary disc 111 by the coin-feeding guide surface 132b in response to the rotation of the rotary disc 111.

An outer guide plate 140 having a thickness slightly larger than that of a coin and a cover 112 for covering the outer guide plate 140 are attached onto the supporting plate 120. The outer guide plate 140, which is made of a rectangular metal plate, has a coin guide surface 141 having a shape of an arc at a center portion thereof, a diameter of the arc being slightly smaller than that of the rotary disc 111. Further, a coin-discharging opening 142 is formed at a coin discharging position (coin discharging unit) of the outer guide plate 140. In the coin discharging opening 142, there are formed notches 143 and 144 for the fixed roller 123 and the displaceable roller 124, respectively. The coin discharging opening 142 is covered by the supporting plate 120 and the cover 112, to thereby form an aperture, i.e., a first outlet 60.

The coin guide surface 141 consists of a first guide surface 141a and a second guide surface 141b. The first guide surface 141a is formed in a shape of an arc having a radius of curvature that is slightly smaller that an outer diameter of the rotary disc 111 when viewed from a center of the rotary disc 111. Further, the second guide surface 141b is formed in a shape of an arc having a radius of curvature that is identical to that of the first guide surface 141a, which is slightly eccentric to a center of the rotary disc 111 toward the coin discharging opening 142. In this way, since the center of the curvature of the second guide surface 141b is eccentric toward the coin discharging opening 142, coins being discharged get closer to the coin discharging opening 142, which makes it possible to discharge coins smoothly.

A roller-attaching bracket 150 is attached to the supporting plate 120. The fixed roller 123 and the displaceable roller 124 are attached to the supporting 120 by the roller-attaching bracket 150, such that the fixed roller 123 and the displaceable roller 124 are protruded from the supporting 120 by a thickness of a coin. The fixed roller 123 is rotatably disposed in the roller-attaching bracket 150 and also positioned in the coin discharging opening 142 such that a cylindrical surface of the fixed roller 123 is disposed in an extending direction of the second guide surface 141b of the outer guide plate 140. The displaceable roller 124, which has an elastic body 124a attached on a cylindrical surface thereof, is rotatably attached at one end of an arm 151. The material of the elastic body 124 is not limited to rubber, but may be plastic.

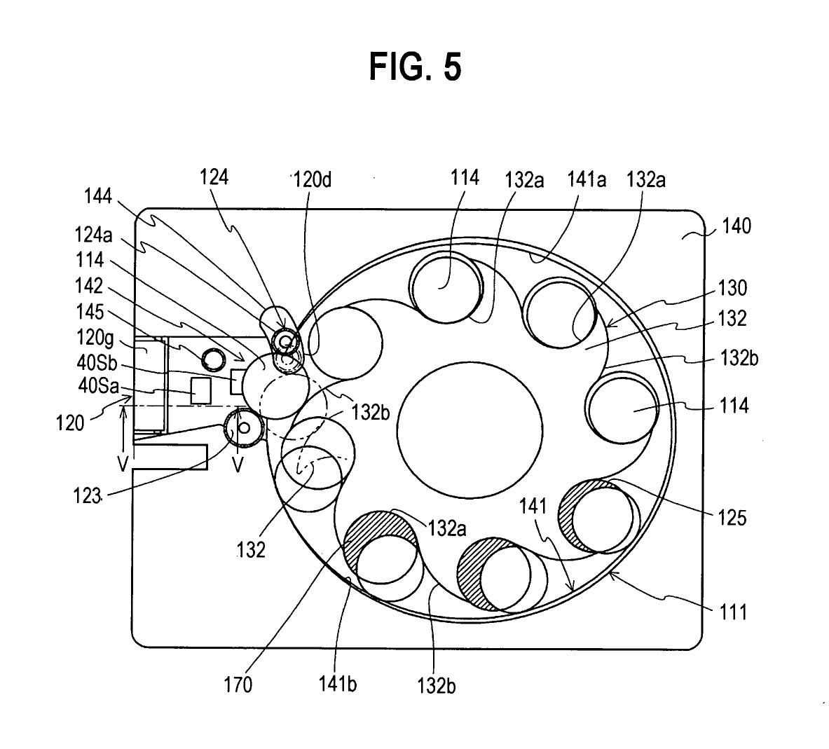

The arm 151 is vibratably attached to the roller-attaching bracket 150 through a rotation axis, i.e., a pivot 150a. The arm 151 displaces the displaceable roller 124 in the notches 150b and 120d between an outlet closing position (a position shown as a dashed dot line in FIG. 5) and an outlet opening position (a position shown as a solid line in FIG. 5). Further, a tension coil spring 152 is attached to the arm 151 to be biased toward a position of closing the displaceable roller 124. At the position of closing the displaceable roller 124, the displaceable roller 124 is set to be positioned on an outer circumference of the rotary disc 111.

Meanwhile, coin detecting units 40Sa and 40Sb for coins being ejected from the first outlet 60 are disposed in a recess 112a of the cover 112. On the cover 112 and the supporting plate 120, detection windows 112b are arranged at positions corresponding to the coin detecting units 40Sa and 40Sb, respectively. As the coin detecting units 40Sa and 40Sb, photo-sensors of reflection type may be employed. The coin detecting units 40Sa and 40Sb defect coins passing therethrough. A shading lid 166 is additionally installed above the recess 112a of the cover 112 to cover the coin detecting units 40Sa and 40Sb. The coin detecting units 40Sa and 40Sb are not limited to photo-sensors of reflection type, but also may be photo-sensors of transparent type.

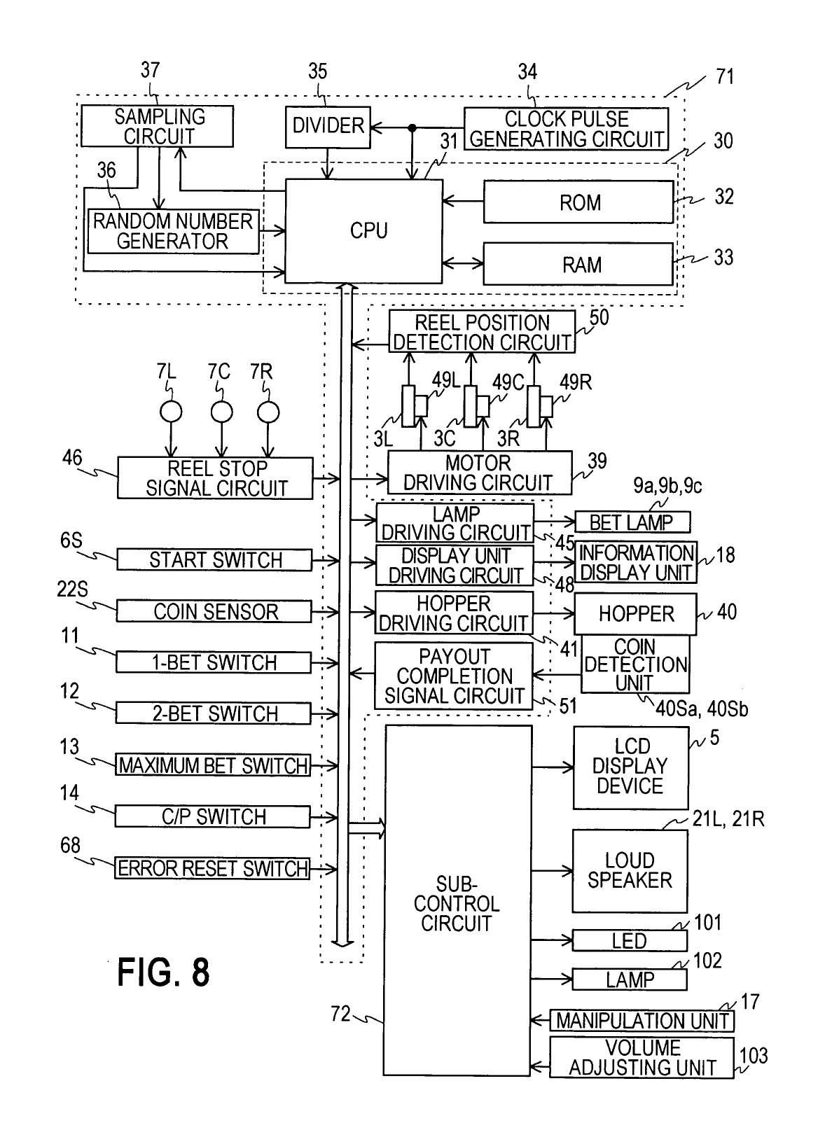

An operation of the hopper 40 (in particular, the motor 121) is controlled by the main control circuit 71, which will be described in detail with reference to FIG. 8. The main control circuit 71 includes a CPU 31, a hopper driving circuit 41 and a payout completion signal circuit 51. The CPU 31 is connected to the hopper driving circuit 41 and the payout completion signal circuit 51. The hopper driving circuit 41 is connected to the motor 121. Further, the payout completion signal circuit 51 is connected to the coin detecting units 40Sa and 40Sb.

Hereinafter, the operation of the hopper 40 will be described in detail. FIG. 5 shows movements of coins guided by the coin-feeding guide plate 130 and the outer guide plate 140 while the coins are being payout.

Assuming that a large amount of coins are accommodated in the bucket 115 (FIG. 3), if the main control circuit 71 determines to perform a payout of coins, the main control circuit 71 outputs a payout instruction signal to the hopper driving circuit 41, which then drives the motor 121. The motor 121 rotates the rotary disc 111 in a clockwise direction as shown in FIG. 5. In this way, the coins accommodated in the bucket 115 vibrate to drop into the supporting plate 120 from the circular openings 125 of the rotary disc 111. Then, coins on the supporting plate 120 are pressed by the coin-feed guide plate 130 rotating along with the rotary disc 111, and guided by the guide surface 141 of the outer guide plate 140 to move toward the coin discharging opening 142.

Since the supporting plate 120 is installed slanted, coins positioning on an upper portion of the rotary disc 111 than a center portion thereof drops because of gravity to be grabbed by the coin-holding guide surface 132a of the coin-feeding guide plate 130. Further, coins positioning on a lower portion of the rotary disc 111 moves because of gravity to contact with the guide surface 141 of the outer guide plate 140. Coins positioning in contact with the second guide surface 141b in the guide surface 141 are guided by the feeding guide surface 132b of the coin-feeding guide plate 130 to get closer to the coin discharging opening 142.

When a coin is positioned in the coin discharging opening 142 by the rotation of the rotary disc 111, the coin contacts with the fixed roller 123. In this state, the coin-feeding guide surface 132b of the guide pawl 132 pushes the coin to displace the displaceable roller 124 to an opening position, such that the coin moves toward a discharging direction. Then, when one end of the guide pawl 132 abuts on the coin, the coin goes over the displaceable roller 124. In this way, the guide pawl 132 does not push the coin any more, and the coin is forcefully ejected by a torque force applied by the tension coil spring 152 of the displaceable roller 124 in a con discharging direction.

The coin ejected by the displaceable roller 124 returning to a closing direction is detected by the coin detecting units 40Sa and 40Sb. Whenever the coin detecting units 40Sa and 40Sb detect the coin being ejected, the payout completion signal circuit 51 outputs a coin detection signal to the CPU 31. Until the number of ejected coins reaches a predetermined number to be paid out, which is determined by the CPU 31, coins are ejected sequentially from the first outlet 60.

While the coin detecting units 40Sa and 40Sb are detecting a coin (i.e., the coin is disposed at a position of the coin detecting units 40Sa and 40Sb), a coin-passing switch (not illustrated) is turned ON. Otherwise, the coin-passing switch is turned OFF. The payout completion signal circuit 51 continuously outputs a coin detection signal while the coin detecting units 40Sa and 40Sb are detecting coins.

It takes a predetermined time for a coin to pass through the coin detecting units 40Sa and 40Sb. Accordingly, if the time during which a coin detection signal is being outputted (i.e., while the coin-passing switch is turned ON) is shorter than the predetermined time (e.g., 2.23 ms 3.35 ms), the CPU 31 regards the coin detection signal as a noise to assume that a payout of coins is not being performed.

The payout completion signal circuit 51 counts the number of coins detected by the coin detecting units 40Sa and 40Sb. When the counted number (i.e., the number of coins payout from the hopper 40) reaches a predetermined number designated by the CPU 31, the payout completing signal circuit 51 outputs a payout completion signal to the CPU 31. Then, the CPU outputs a payout stop instruction signal to the hopper driving circuit 41, which stops the rotation of the motor 121. In this case, the rotation of the motor 121 is immediately stopped. In the embodiment of the present invention, the rotation of the motor 121 is controlled such that the hopper 40 pays out ten coins per second (i.e., one coin per 0.1 second).

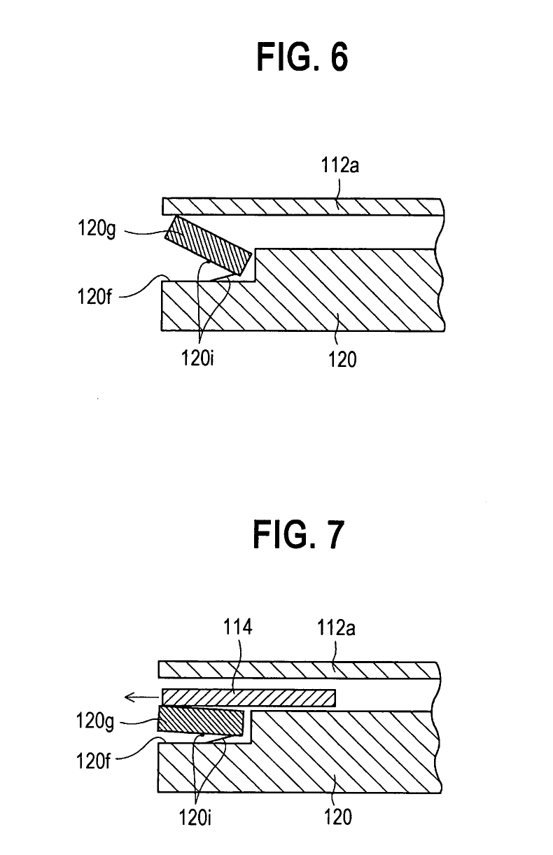

FIGS. 6 and 7 show cross-sectional views of the coin discharging unit taken along the line V-V in FIG. 5.

FIG. 6 shows a cross-sectional view of the coin discharging unit through which any coin is not being payout. One end of the screening member 120g is urged by the Kamome spring 120i(120h) to contact with a rear side of the recess 112a of the cover 112. In this way, the screening member 120g is biased to block out the first outlet 60, through which anything cannot be inserted into the hopper 40. Therefore, any “inappropriate act” to steal coins from the coin payout outlet 15 by inserting a wire such as a piano wire into the hopper 40 can be prevented.

FIG. 7 shows a cross-sectional view of the coin discharging unit through which a coin is being paid out. As shown in FIG. 7, the coin is being ejected forcefully in a coin discharging direction to reach a position of the screening member 120g, such that the screening member 120g is pushed below by the coin. In this way, the coin is ejected from the first outlet 60. Therefore, any inappropriate act against the hopper 40 is prevented while a coin is being payout. Further, the urging force of the Kamome spring 120i(120h) is determined so as to be suitable for a coin to push the screening member 120g inside the stepped portion 120f.

In the following, a configuration of a control unit of the game machine and peripheral devices connected thereto will be described in detail with reference to FIG. 8. The control unit of the game machine 1 includes a main control circuit 71 and a sub-control circuit 72.

FIG. 8 describes the main control circuit 71 for controlling an operation of processing a game, a peripheral device (an actuator) connected electrically to the main control circuit 71, and a sub-control circuit 72 for controlling an LCD display device 5, loud speakers 21L and 21R, an LED 101 and a lamp 102 in response to a control signal outputted from the main control circuit 71.

The main control circuit 71 includes a microcomputer 30 installed on a circuit board in addition to a circuit for providing a function of sampling a random number. The microcomputer 30 includes a CPU 31 for performing a control operation in accordance with a predetermined program, and storage means, i.e., ROM 32 and RAM 33.

A clock pulse generating circuit 34 for generating a reference clock pulse, a divider 35, a random number generator 36 for generating a random number and a sampling circuit 37 are connected to the CPU 31. A random number sampling means may be implemented by executing a program for sampling a random number in the CPU 31 of the microcomputer 30. In this case, the random number generator 36 and the sampling circuit 37 may be omitted or reserved for a random number sampling operation.

The ROM 32 of the microcomputer 30 stores therein a probability lottery table for determining a random number whenever a start lever 6 is manipulated (start manipulation), a group of stop tables for determining a mode of stopping reels according to a manipulation of the stop buttons 7L, 7C and 7R, and various control instructions (commands) to be transmitted to the sub-control circuit 72. The main control circuit 71 performs only a unidirectional communication with the sub-control circuit 72 while the sub-control circuit 72 does not transmit any command or information to the main control circuit 71. The RAM 33 stores therein various information, e.g., information on credit mode (ON/OFF), a counter of credit number, a counter of the number of coins payout and a status of playing game.

As shown in FIG. 8, the microcomputer 30 outputs a control signal to control actuators such as BET lamps (an 1-BET lamp 9a, a 2-BET lamp 9b and a maximum BET lamp 9c), an information display unit 18, the hopper 40 for accommodating coins and paying out a predetermined number of coins in response to an instruction from the hopper driving circuit 41, and stepping motors 49L, 49C and 49R for driving the rotation of the reels 3L, 3C and 3R, respectively.

Further, an output of the CPU 31 is connected to a motor driving circuit 39 for controlling the operation of the stepping motors 49L, 49C and 49R, a hopper driving circuit 41 for controlling the operation of the hopper 40 (particularly the motor 121), a lamp driving circuit 45 for controlling the operation of the BET lamps 9a, 9b and 9c, and a display unit driving circuit 48 for controlling the operation of the information display unit 18. These driving circuits receive a control signal indicating a driving instruction from the CPU 31 to control the operation of the actuators.

A start switch 6S, an 1-BET switch 11, a 2-BET switch 12, a maximum BET switch, a C/P switch 14, a coin sensor 22S, a reel stop signal circuit 46, a reel position detection circuit 50 and an error reset circuit 68 generates input signals to be transmitted to the microcomputer 30 to generate a control signal.

The start switch 6S detects a manipulation of the start lever 6. The coin sensor 22S detects a coin being inserted into the coin insertion slot 22. The reel stop signal circuit 46 outputs a stop signal in response to a manipulation of the stop buttons 7L, 7C and 7R. The reel position detection circuit 50 receives a pulse signal from a reel rotation sensor to output a signal for detecting a position of each of the reels 3L, 3C and 3R to the CPU 31.

In FIG. 8, the random number generator 36 generates random numbers within a certain range. The sampling circuit 37 selects one of the random numbers at a certain point of time after the start lever 6 is manipulated. An internal winning combination is determined based on the sampled random number and the probability lottery table stored in the ROM 32. The probability lottery table includes information on internal winning combinations such as BB (a combination continuous operation device related to a first bonus combination), RB (a first bonus combination), a small combination, a failure to win (nothing) and information on a range of random numbers to determine such internal winning combinations.

After the rotation of the reels 3L, 3C and 3R starts, the number of driving pulses provided to each of the stepping motors 49L, 49C and 49R is counted, which is recorded in a certain area of the RAM 33. A reset pulse is obtained from each of the reels 3L, 3C and 3R per one rotation thereof, which is inputted to the CPU 31 through the reel position detection circuit 50. Then, the CPU 31 resets the number of counted driving pulses stored in the RAM 33 into “0” in response to the reset pulse. In this way, the counted numbers corresponding to the rotation positions of the reels 3L, 3C and 3R per one rotation thereof is stored in the RAM 33.

A symbol table (not illustrated) stored in the ROM 32 is used to match the rotation positions of the reels 3L, 3C and 3R to symbols printed on outer circumference surfaces of the reels. In the symbol table, based on the rotation positions of the reels when the reset pulse is generated, code numbers generated sequentially at periodical pitches of the rotating reels 3L, 3C and 3R and symbol codes representing symbols corresponding to the code numbers respectively are stored.

Further, a winning symbol combination table is stored in the ROM 32. In the winning symbol combination table, winning symbol combinations, corresponding winning coin payout numbers and winning determination codes are stored. The winning symbol combination table is referred to check whether to win a game when each of the reels 3L, 3C and 3R is stopped or all of them are stopped.

In case an internal winning combination is determined by a lottery processing (probability lottery processing) based on the sampled random number, the CPU 31 transmits a signal for controlling the reels 3L, 3C and 3R to stop, based on a manipulation signal outputted from the reel stop signal circuit 46 at the time of the stop buttons being manipulated by a player, and a selected stop table.

In case the symbols indicated by the stopped reels 3L, 3C and 3R represents an internal winning combination to payout coins, the CPU 31 outputs a payout instruction signal to the hopper driving circuit 41 such that a predetermined number of coins are paid out from the hopper 40.

Meanwhile, the coin detection units 40Sa and 40Sb detects a coin being ejected one by one. If the coin detection units 40Sa and 40Sb detect a coin being ejected, the payout completion signal circuit 51 transmits a coin detection signal to the CPU 31. Further, the payout completion signal circuit 51 counts the number of coins detected by the coin detection units 40Sa and 40Sb. If the counted number (i.e., the number of coins payout from the hopper 40) reaches a predetermined number set by the CPU 31, the payout completion signal circuit 51 outputs a payout completion signal to the CPU 31.

If the CPU 31 determines that the payout of coins is completed, the CPU 31 outputs a payout stop instruction signal to the hopper driving circuit 41, which stops the operation of the motor 121 of the hopper 40 in response to the payout stop instruction signal. In this way, a processing of coin payout is completed.

If the coin detection signal is being output from the payout completion signal circuit 51 for more than a predetermined time (e.g., 200 ms) (i.e., the coin passing detection switch is turned ON for the predetermined time), the CPU 31 determines that a jam error has occurred.

Further, if the coin detection signal is not received for more than a predetermined time (e.g., 1500 ms) after the CPU 31 outputs a payout instruction signal to the hopper driving circuit 41 or receives a coin detection signal, the CPU 31 determines that an empty error has occurred.

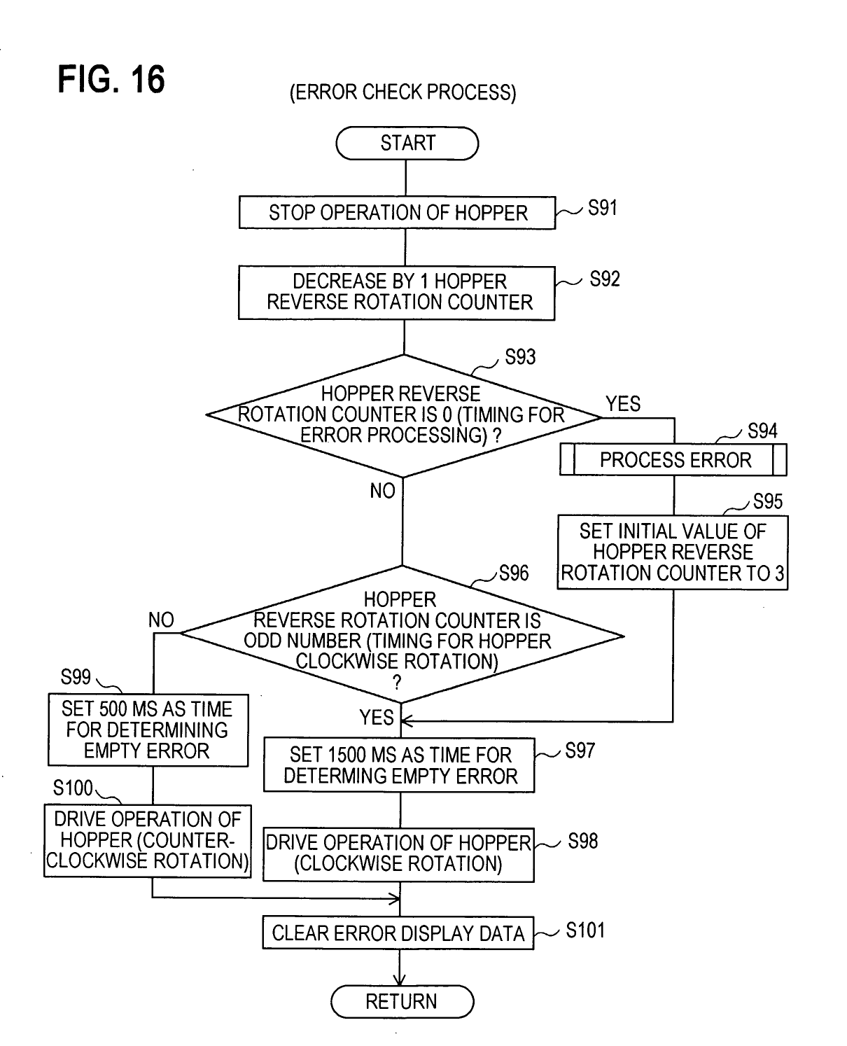

When any of the above-described errors has occurred, the CPU 31 drives the motor 121 to rotate the rotary disc 111 in a counterclockwise direction and again in a clockwise direction, as shown in FIG. 5, to thereby remove a cause of the error or confirm the occurrence of the error (a method for processing an error will be described later with reference to FIG. 16).

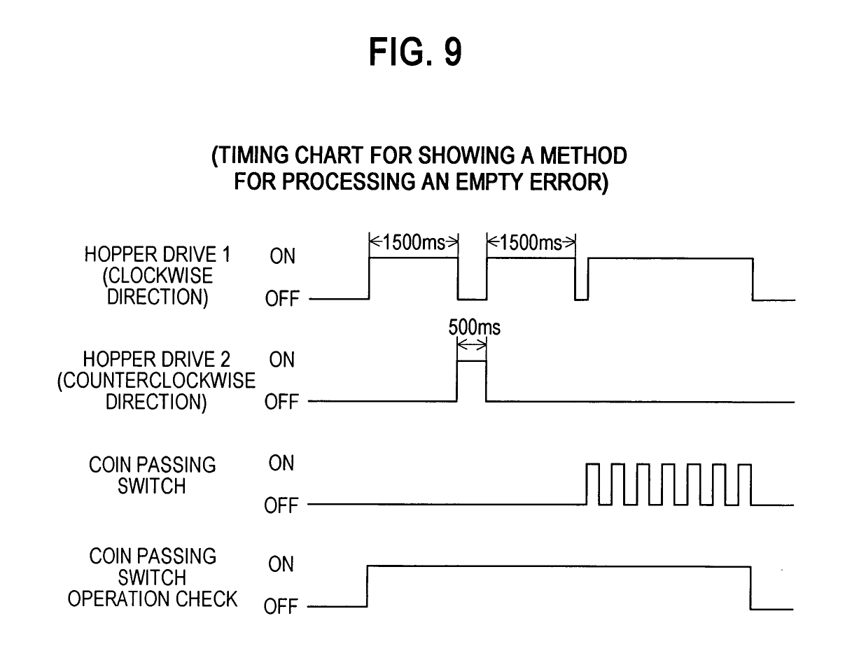

FIG. 9 is a timing chart showing an operation of the motor 121 and an operation to check a status of the coin-passing switch.

A signal “HOPPER DRIVE 1” indicates ON in case the rotary disc 111 rotates in a clockwise direction. Otherwise, the signal “HOPPER DRIVE 1” indicates OFF. A signal “HOPPER DRIVE 2” indicates ON in case the rotary disc 111 rotates in a counterclockwise direction. Otherwise, the signal “HOPPER DRIVE 2” indicates OFF.

A signal “COIN-PASSING SWITCH” indicates ON while the coin detection units 40Sa and 40Sb are detecting a coin being ejected. Otherwise, the signal “COIN-PASSING SWITCH” is turned OFF. Until a payout completion signal is outputted after a payout instruction signal is outputted, the CPU 31 checks an operation of the coin passing switch irrespective of the rotation direction of the rotary disc 111. While the CPU 31 is checking the operation of the coin-passing switch, the signal “COIN-PASSING SWITCH OPERATION CHECK” indicates ON. Otherwise, the signal COIN-PASSING SWITCH OPERATION CHECK” indicates OFF.

First, the CPU 31 outputs a payout instruction signal and then the signal “HOPPER DRIVE 1” turns ON. Even after 1500 ms elapses since the signal “HOPPER DRIVE 1” has turned ON, the signal “COIN-PASSING SWITCH” is maintained OFF. After 1500 ms passes after the payout instruction signal is outputted, the signal “HOPPER DRIVE 1” is turned OFF and the signal “HOPPER DRIVE 1” is turned ON (i.e., the rotary disc 111 begin to rotate in a counterclockwise direction).

After the signal “HOPPER DRIVE 2” is turned ON and 500 ms passes, the signal “HOPPER DRIVE 2” is turned OFF and the signal “HOPPER DRIVE 1” is turned ON. After the signal “HOPPER DRIVE 1” is turned ON and 1500 ms passes, the CPU 31 determines that an empty error has occurred and then both the signals “HOPPER DRIVE 1” and “HOPPER DRIVE 2” are turned OFF (i.e., the rotation of the rotary disc 111 is stopped).

Thereafter, an operator of an arcade refills the hopper 40 with new coins and manipulates an error reset switch 68, such that a normal operation of paying out coins is resumed. As shown in FIG. 9, the signal “COIN-PASSING SWITCH” is turned ON seven times, which means that seven coins are paid out. Then, with the completion of the payout of seven coins, the signal “COIN-PASSING SWITCH OPERATION CHECK” is turned OFF.

In the present embodiment, even while the rotary disc 111 is rotating in a counterclockwise direction (i.e., in a direction of any coins not being payout), the CPU 31 checks the operation of the coin-passing switch. Therefore, for example, in case a coin contacts with the fixed roller 123 and the displaceable roller 124, but is positioned a position which the coin detection unit 40Sb cannot detect, the rotary disc 111 rotates in a counterclockwise direction to payout the coin, such that the CPU 31 determines that the coin has been payout.

Further, in case a jam error has occurred, the CPU 31 controls the rotary disc 111 to rotate in a counterclockwise direction while checking the operation of the coin-passing switch. Accordingly, for example, in case a coin is paused at a position which the coin detection units 40Sa and 40Sb can detect, the rotary disc 111 rotates in a counterclockwise direction to payout the coin, such that the CPU 31 determines the coin has been payout (i.e., the coin detection switch is turned OFF).

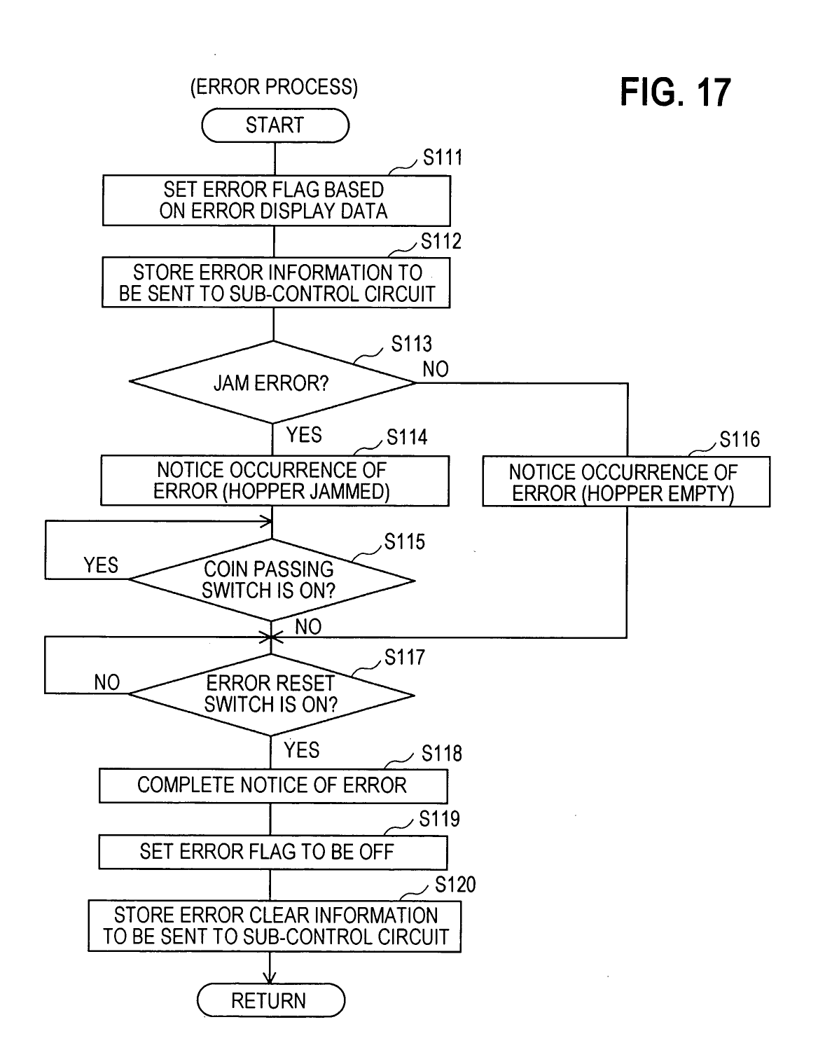

Meanwhile, in case a jam error has occurred, in order to solve a problem that the hopper 40 is full of coins, the rotary disc 11 rotates by 200 ms in a clockwise direction, 200 ms in a counterclockwise direction and once more 200 ms in a clockwise direction. Even after such an operation of the rotary disc 111, if the coin detection switch is not turned OFF, a method for processing an error is performed, which will be described later (FIG. 17).

As described above, the CPU 31 checks the operation of the coin-passing switch (i.e., monitoring whether a coin detection signal is outputted or not) even in case the rotary disc 111 rotates in a counterclockwise direction. That is, by checking the operation of the coin-passing switch irrespective of the rotation direction of the rotary disc, the game machine can determine more precisely the number of coins being payout compared to the case of checking the operation of the coin-passing switch only when the rotary disc rotates in a clockwise direction.

Further, the number of coins payout, which is detected by the game machine, may be transferred to a so-called “hall computer.” That is, the hall computer determines more precisely the number of coins payout to detect a mismatch between the number of coins paid out detected by the game machine and the number counted by the coin counter. By checking such a mismatch, it is possible to find easily any inappropriate act, which makes the management of the arcade more efficient.

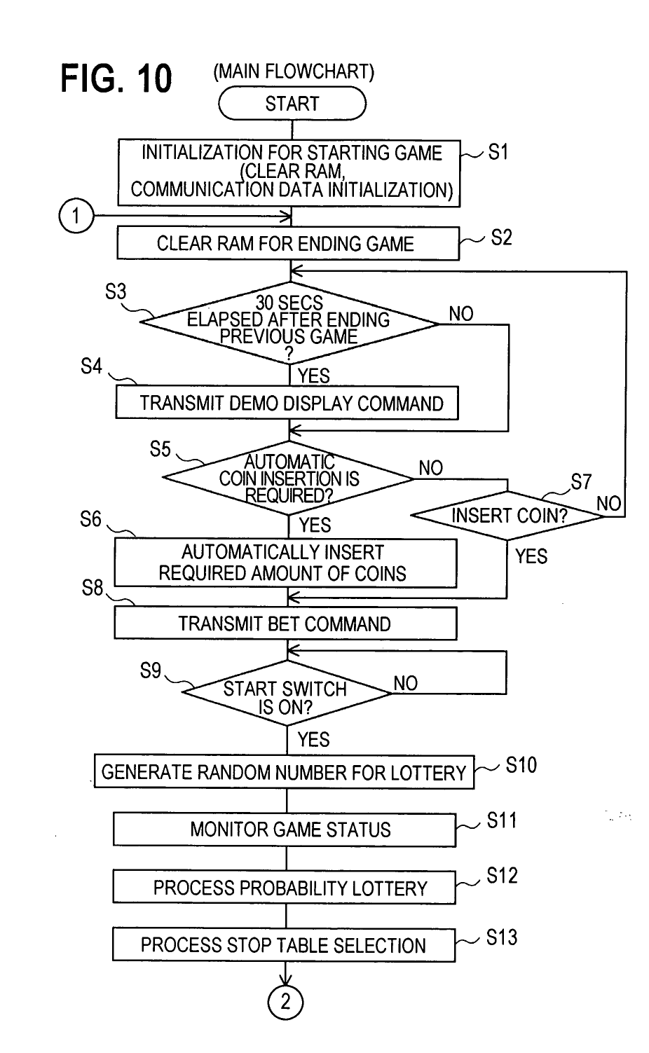

In the following discussion, the operation of the main control circuit 71 will be described in detail with reference to FIGS. 10 to 12.

First, the CPU 31 performs an initialization step for starting a game (step S1). Particularly, the CPU 31 initializes data stored in the RAM 33 and communication data. Thereafter, the CPU 31 removes data stored in a certain address space (e.g., a space for storing an internal winning combination) of the RAM 33 at the time of completing a game (step S2).

In particular, in the initialization step, data stored in a writable area of the RAM 33 in a previous game is removed, parameters for the next game is recorded in the writable area, and a starting address of a sequence program for the next game is assigned. Next, it is checked whether 30 seconds have passed after the completion of the previous game, i.e., the pause of the reels 3L, 3C and 3R (step S3). If the condition of the step S3 is satisfied (“YES”), the CPU 31 transmits a “demo display command” for requesting a display of a “demo screen” to the sub-control circuit 72 (step S4), proceeds to the step S5. Otherwise (“NO”), proceeds to the step S5.

In the step S5, the CPU 31 checks whether an automatic insertion of coins is requested, i.e., whether a replay winning combination is established in the previous game. If the condition of the step S5 is satisfied (“YES”), the required amount of coins are automatically inserted (step S6), proceeds to the step S8. Otherwise (“NO”), the CPU 31 checks whether any signal from the coin sensor 22S or the BET switches 11 to 13 are inputted thereto (step 7). If the condition of the step 7 is satisfied (“YES”), proceeds to the step S8. Otherwise (“NO”), proceeds to the step S3.

In the step S8, the CPU 31 sends a “BET command” to the sub-control circuit 72 to indicate that a manipulation of the BET switches 11 to 13 or inserting coins are performed. Thereafter, it is checked whether any signal from the start switch 6S triggered by a manipulation of the start lever 6 is inputted thereto (step S9). If the condition of the step S9 is satisfied (“YES”), proceeds to the step S10. Otherwise (“NO”), the step S9 is performed repetitively. In the step S10, a random number for lottery is generated. The generated random number is used in a probability lottery processing, which will be described later. Sequentially, a processing of monitoring a game status is performed (step S11).

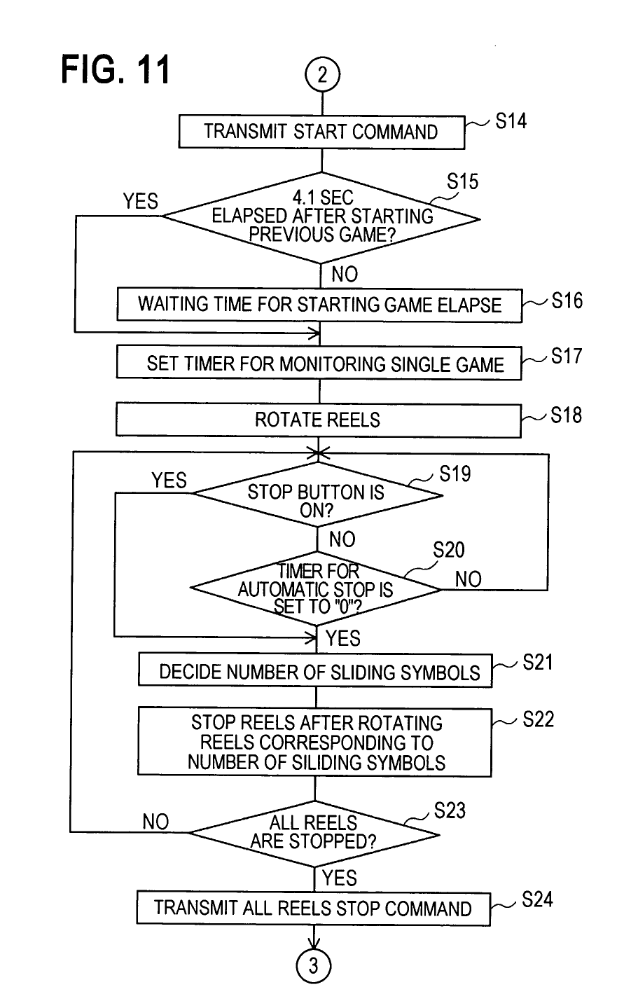

Next, the CPU 31 performs a probability lottery process (step S12). In the probability lottery process, the CPU 31 uses the probability lottery table stored in the ROM 32 to determine an internal winning combination based on the game status and the random number generated in the step S1. Sequentially, a stop table is selected to control the rotation of the reels 3L, 3C and 3R to stop (step S13), and then proceeds to the step S14 (FIG. 11).

As shown in FIG. 11, in the step S14, the CPU 31 transmits a “start command” to the sub-control circuit 72, and then proceeds to the step S15. The start command includes information on a game status and an internal winning combination. In the step S15, it is checked whether “4.1 seconds” has elapsed since a previous game started. If the condition of the step S15 is satisfied (“YES”), proceeds to the step S17. Otherwise (“NO”), proceeds to the step S16. In the step S16, time for waiting game start elapses, and then proceeds to the step S17. Particularly, until predetermined time (e.g., “4.1 seconds”) elapses after a previous game starts, any input signal generated according to a player's manipulation for starting a game is invalidated.

In the step S17, the CPU 31 sets a timer for monitoring a single game. The timer for monitoring a single game includes an automatic stop timer for stopping automatically the reels 3L, 3C and 3R, which is not caused by a player's manipulation of the stop buttons 7L, 7C and 7R. Sequentially, a process for rotating the reels 3L, 3C and 3R is performed (step S18), and then proceeds to the step S19.

In the step S19, the CPU 31 checks whether the stop button is turned “ON”. In particular, it is checked whether any one of the stop buttons 7L, 7C and 7R is manipulated. If the condition of the step S19 is satisfied (“YES”), proceeds to the step S21. Otherwise (“NO”), proceeds to the step S20. In the step S20, it is checked whether a value of an automatic stop timer is “0”. If the condition of the step S20 is satisfied (“YES”), proceeds to the step S21. Otherwise (“NO”), proceeds to the step S19.

In the step S21, the CPU 31 executes a sliding-symbol-number deciding process. Thereafter, the reels 3L, 3C and 3R rotates in a number of sliding symbols determined in the step S21 in response to manipulations of the stop buttons 7L, 7C and 7R, respectively (step S22). Then, it is checked whether all of the reels 3L, 3C and 3R are stopped (step S23). If the condition of the step S23 is satisfied (“YES”), it proceeds to the step S24. Otherwise (“NO”), it proceeds to the step S19. In the step S24, the CPU 31 transmits a “all reels stop command” to the sub-control circuit 72 for indicating that all the reels 3L, 3C and 3R are stop, and then proceeds to the Step S25.

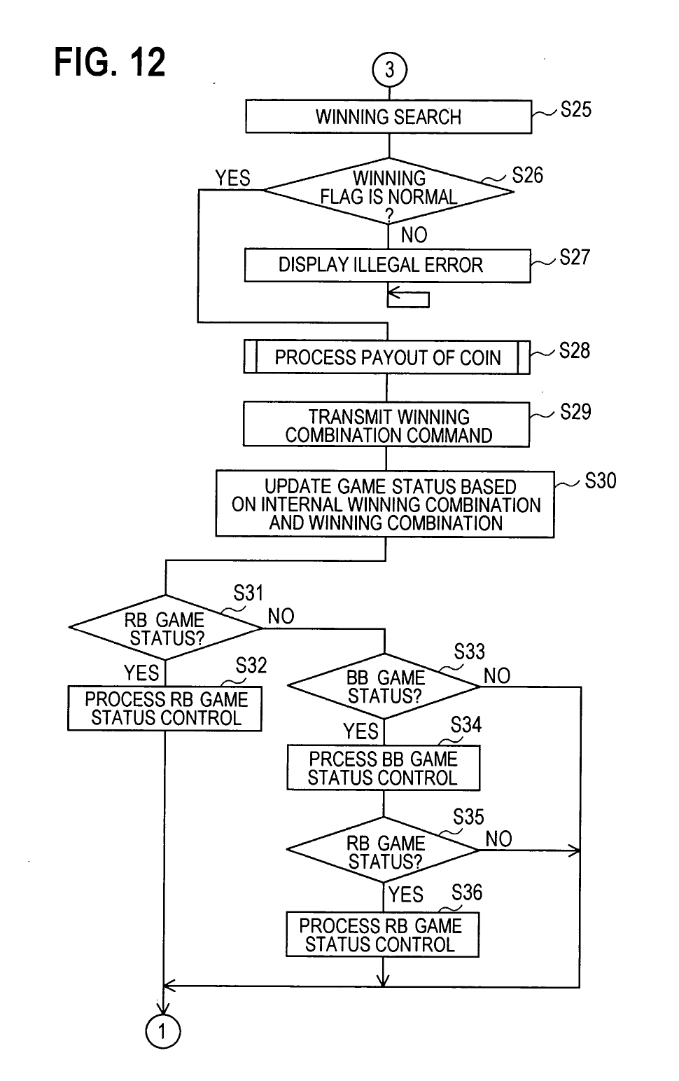

As shown in FIG. 12, in the step S25, the CPU 31 performs a winning search. The winning search means setting a winning flag to identify a winning combination based on symbols displayed on the display windows 4L, 4C and 4R when the reels are stopped. In particular, a winning combination is identified based on a winning determination table and code numbers corresponding to symbols arranged on the center line 8c.

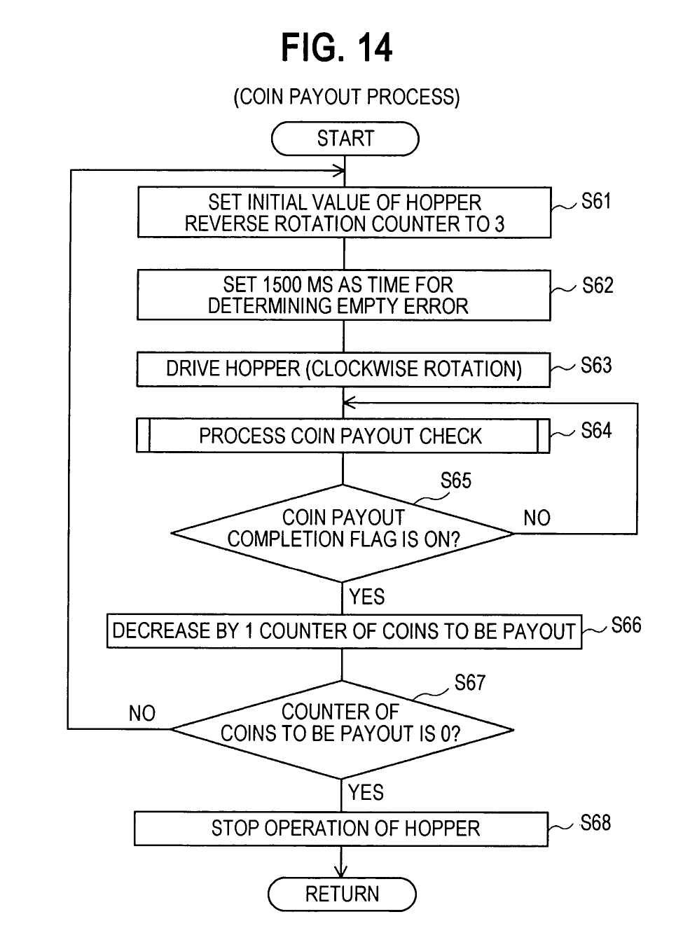

Thereafter, it is checked whether the winning flag is set to be normal (step S26). If the condition of the step S26 is satisfied (“YES”), proceeds to the step S28. Otherwise (“NO”), it proceeds to the step S27. In the step S27, a process of displaying an illegal error is performed. In this case, playing a game is stopped. In the step S28, a process of coin payout is performed, which will be described later with reference to FIG. 14, and then proceeds to the step S29. In the step S29, a winning combination command is transmitted, and then proceeds to the step S30.

Next, the CPU 31 updates a game status based on a previous game status, an internal winning combination, a winning combination and the like (step S30). In particular, the game status is updated to a BB game status and an RB game status if BB and RB combinations are won, respectively.

Then, the CPU 31 checks whether a current game status is an RB game status occurred in a general game status (step S31). If the condition of the step S31 is satisfied (“YES”), it proceeds to the step S32. Otherwise (“NO”), it proceeds to the step S33.

In the step S32, a process of controlling an RB game status is performed, and then proceeds to the step S2 (FIG. 10). In the step S32, information on number (the number of games and the number of winning a game) is updated, and it is determined whether to maintain an RB game status or transit to a general game status based on the information on number.

If the condition of the step S31 is not satisfied (“NO”), it is checked whether a current game status is a BB game status or not (step S33) and then proceeds to the step S2 (FIG. 10). Otherwise (“YES”), it proceeds to the step S34.

In the step S34, a process of controlling a BB game status is performed and then it proceeds to the step S35. In the step S34, it is determined whether a transition from a general game status to an RB game status is performed in a BB game status, or whether a transition to a general game status is performed.

In the step S35, it is determined whether a current game status is an RB game status and a BB game status. If the condition of the step S35 is satisfied (“YES”), proceeds to the step S36. Otherwise (“NO”), it proceeds to the step S2 (FIG. 10).

In the step S36, a process of controlling an RB game status is performed, and then it proceeds to the step S2 (FIG. 10). In the step S36, information on number (the number of games and the number of winning a game) is updated, and it is determined whether to maintain an RB game status or transit from a BB game status to a general game status based on the information on number.

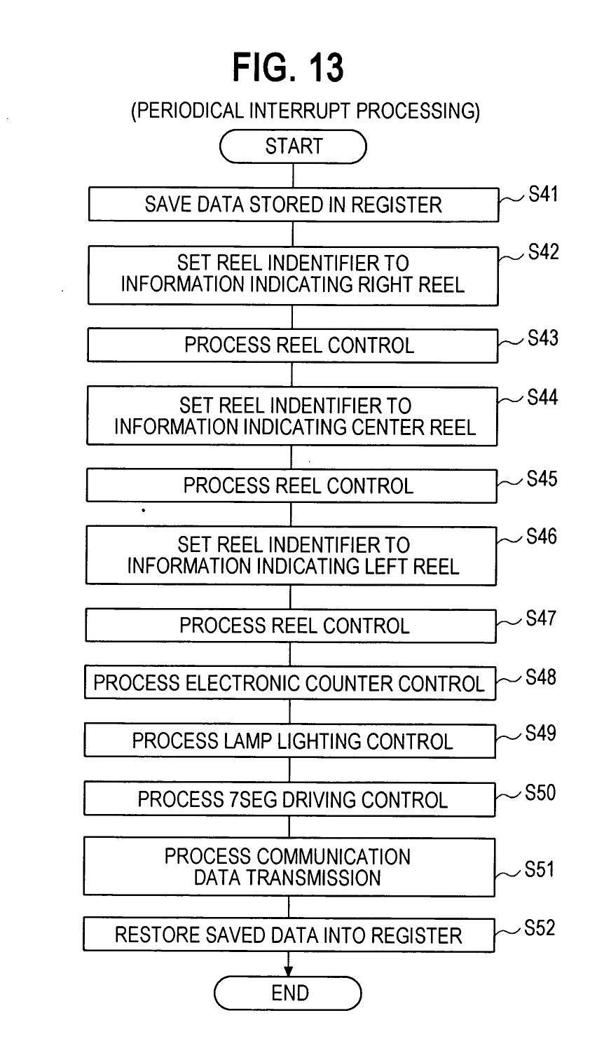

Referring to FIG. 13, a method for processing a periodical interrupt will be explained in the following. In the periodical interrupt processing, an interrupt occurring at a predetermined interval (e.g., 1.8773 ms) is processed during the main process (main flowchart) executed by the main control circuit 71.

First, the CPU 31 saves data stored in a register (step S41), and then proceeds to the step S42. In the step S42, information on the right reel 3R is stored as “reel identification information” indicating information on the reels 3L, 3C and 3R, which is stored in the RAM 33, and then proceeds to the step S43.

In the step S43, a process of controlling the right reel 3R is performed, and then proceeds to the step S44. In particular, starting rotation, accelerating, maintaining a rotation speed, decelerating and stopping of the right reel 3R is controlled in the step S43. In the step 44, information on the center reel 3C is stored as the “reel identification information”, and then it proceeds to the step S45.

In the step S45, a process of controlling the center reel 3C is performed, and then proceeds to the step S46. In particular, starting rotation, accelerating, maintaining a rotation speed, decelerating and stopping of the center reel 3C is controlled in the step S45. In the step 46, information on the left reel 3L is stored as the “reel identification information”, and then it proceeds to the step S47.

In the step S47, a process of controlling the left reel 3L is performed, and then proceeds to the step S48. In particular, starting rotation, accelerating, maintaining a rotation speed, decelerating and stopping of the left reel 3L is controlled in the step S47.

In the step S48, a process of controlling an electronic counter is performed, and then proceeds to the step S49. In particular, a coin selector is controlled to determine whether a coin inserted into the coin insertion slot 22 is a normal coin or not.

In the step S49, a process of controlling a lighting of a lamp is performed, and then it proceeds to the step S50. In particular, various lamps installed on a front surface of the cabinet 2 are controlled to be lighted differently.

In the step S50, a process of controlling an operation of a seven-segrnented LED is performed, and then it proceeds to the step S51. In the step S51, a transmission of communication data is performed, and then proceeds to the step S52. In particular, various commands are transmitted to the sub-control circuit 72. In the step S52, the saved data is restored in the register.

Hereinafter, a coin payout process will be described in detail with reference to FIG. 14.

First, the CPU 31 sets an initial value of a hopper reverse rotation counter to “3” (step S61), and then proceeds to the step S62. The value of the hopper reverse rotation counter is used to determine whether a rotation direction of the rotary disc 111 is converted (step S96 of FIG. 16 to be described later) and whether an error has occurred or not (step S93 of FIG. 16 to be described later). Particularly, the value of the hopper reverse rotation counter indicates the number of conversion of the rotation direction of the rotary disc 111.

That is, if the value of the hopper reverse rotation counter is updated to an even number other than 0, the rotary disc 111 rotates in a counterclockwise direction. If the value of the hopper reverse rotation counter is updated to an odd number, the rotary disc 111 rotates in a clockwise direction. If the value of the hopper reverse rotation counter is set to 0, it is determined that an error has occurred.

In the step S62, time for determining an empty error is set to 1500 ms, and then proceeds to the step S63. The time for determining an empty error means time required to determine whether an empty error has occurred and, particularly, time during which the rotary disc 111 is rotating in one of a clockwise rotation direction and a counterclockwise rotation direction. The time for determining an empty error is set to 1500 ms or 500 ms.

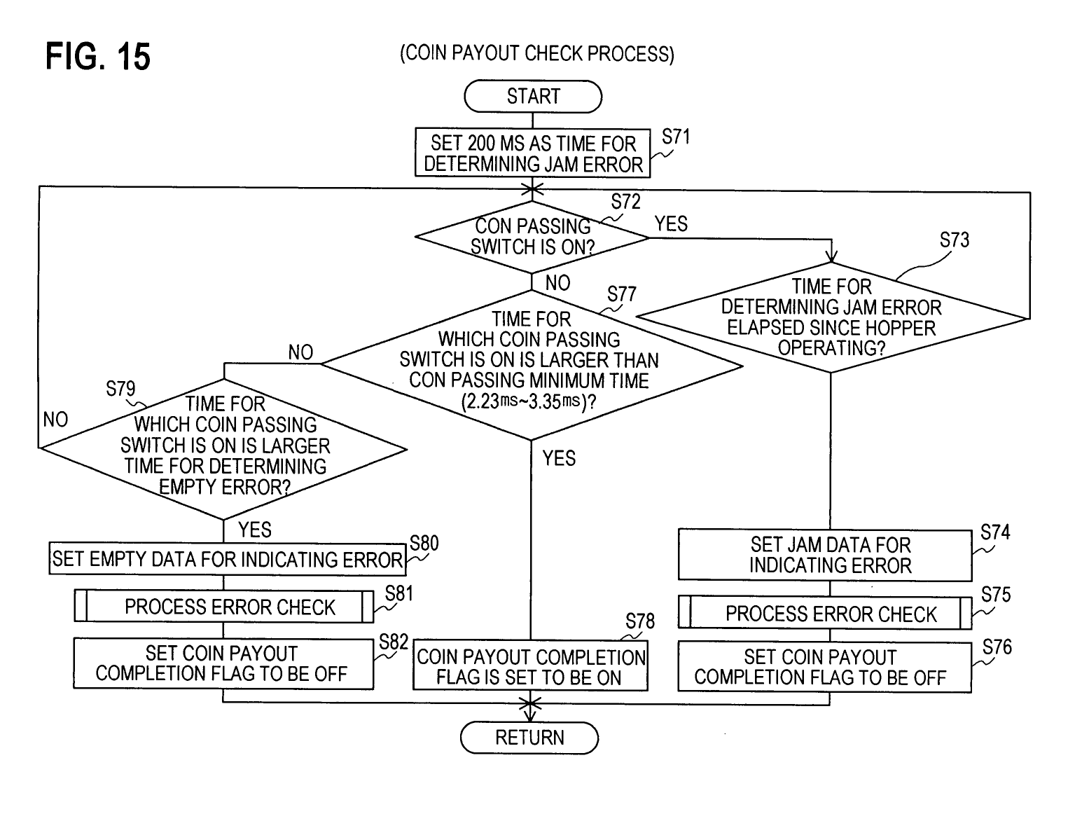

In the step S63, the hopper 40 (rotary disc 111) is rotated in a clockwise rotation direction, and then proceeds to the step S64. In the step S64, a process of checking coin payout, which will be described later referring to FIG. 15, is performed, and then proceeds to the step S65.

In the step S65, it is checked whether a coin payout completion flag is ON or not. If the condition of the step S65 is satisfied (“YES”), proceeds to the step S66. Otherwise (“NO”), proceeds to the step S64. The coin payout completion flag indicates whether a payout of a coin is completed or not. If the flag is set to ON, it means that a payout of a coin is completed. Otherwise, if the flag is set to OFF, it means that a process for paying out a coin has been performed but actually not paid out.

In the step S66, since the coin payout completion flag is ON, an estimated payout coin counter is decreased by 1 and then proceeds to the step S67. The estimated payout coin counter stores information on the number of coins to be paid out according to a winning combination.

In the step S67, it is checked whether the estimated payout coin counter is 0. If the condition of the step S67 is satisfied (“YES”), proceeds to the step S68. Otherwise (“NO”), since the number of coins to be paid out according to a winning combination has not been paid out, proceeds to the step S61. In the step S68, the rotation of the hopper 40 (rotary disc 111) is stopped, and then proceeds to the step S29 (FIG. 12).

Now referring to FIG. 15, a process of checking coin payout will be described.

First, the CPU 31 sets time for determining a jam error to 200 ms, and then proceeds to the step S72. The time for determining a jam error means time required to determine whether a jam error has occurred and, particularly, the time during which the rotary disc 111 is rotating in either a clockwise or counterclockwise rotational direction. Further, in the present embodiment, the time for determining a jam error is set only to 200 ms.

In the step S72, it is determined whether the coin passing switch is turned ON (i.e., whether a coin detection signal is outputted). If the condition of the step S72 is satisfied (“YES”), proceeds to the step S73. Otherwise (“NO”), proceeds to the step S77.

In the step S73, it is determined whether the time for determining a jam error elapses since the hopper 40 has been driven (e.g., the execution of the step S71). If the condition of the step S73 (“YES”), since it means that the status of the coin detection switch being ON is maintained for 200 ms, i.e., a jam error has occurred, proceeds to the step S74. Otherwise (“NO”), proceeds to the step S72.

In the step S74, jam data is set as error display data, and then proceeds to the step S75. The jam data is used to perform the step S113 to be described later with reference to FIG. 17. In the step S76, a process of checking an error is performed, which will be described later with reference to FIG. 16, and then proceeds to the step S76. In the step S76, the coin payout completion flag is set to OFF, and then proceeds to the step S65 (FIG. 14). Further, since the coin payout completion flag is set to OFF, a process of checking coin payout is resumed.

In the step S77, in case the coin passing switch is turned ON (i.e., the condition of the step S72 is satisfied (“YES”)), it is checked whether time during which the coin passing switch is ON is larger than coin passing minimum time (e.g., 2.23 ms˜3.35 ms).

In case a coin is passed through the coin detection units 40Sa and 40Sb, the condition of the step S72 is satisfied (“YES”) (i.e., the coin passing switch is ON) for at least a predetermined time (e.g., the coin passing minimum time). Meanwhile, due to an occurrence of noise, it is also possible for the CPU 31 to determine that the condition of the step S72 is satisfied (“YES”).

Therefore, in the step S77, in case the coin passing switch is turned OFF after being ON for a certain time, it is checked whether the duration of the coin passing switch being ON is larger than the coin passing minimum time, to thereby determine whether the coin passing switch is turned ON due to noise.

If the condition of the step S77 is satisfied (“YES”), proceeds to the step S78. Otherwise (“NO”), proceeds to the step S79. In the step S78, since a coin has passed through the coin detection units 40Sa and 40Sb to be paid out normally, the coin payout completion flag is turned ON and then proceeds to the step S65 (FIG. 14).

If the condition of the step S77 is satisfied (“YES”), it means that a coin is positioned at the coin detection units 40Sa and 40Sb and thus the condition of the step S72 is satisfied (“YES”) and, thereafter, the coin has passed through the coin detection units 40Sa and 40Sb and thus the condition of the step S72 is not satisfied (“NO”). Otherwise (“NO”), it means that a coin has not been paid out and thus the coin passing switch is not turned ON.

In the step S79, it is checked whether time during which the coin passing switch is ON is larger than the time for determining an empty error, i.e., whether an empty error has occurred or not. If the condition of the step S79 is satisfied (“YES”), proceeds to the step S80. Otherwise (“NO”), proceeds to the step S72.

In the step S80, empty data is set as error display data, and then proceeds to the step S81. The empty data is used to perform the step S113 of FIG. 17, which will be described later. In the step S82, a process of checking an error is performed, which will be described later, and then proceeds to the step S82. In the step S82, the coin payout completion flag is turned OFF, and then proceeds to the step S65.

Referring to FIG. 16, a method for checking an error now will be explained in detail.

First, in the step S91, the CPU 31 stops the rotation of the hopper 40 (rotary disc 111), and then proceeds to the step S92. In the step S92, the hopper reverse rotation counter is decreased by 1, and then proceeds to the step S93. In the step S93, it is determined whether the hopper reverse rotation counter is 0. If the condition of the step S93 is satisfied (“YES”), proceeds to the step S94. Otherwise (“NO”), proceeds to the step S96.

In the step S94, an error processing is performed, which will be described later with reference to FIG. 17, and then proceeds to the step S95. In the step S95, an initial value of the hopper reverse rotation counter is set to 3, and then proceeds to the step S97.

In the step S96, it is checked whether the hopper reverse rotation counter is set to an odd number (i.e., whether it is time to start the rotation of the rotary disc 111 in a clockwise rotation direction). If the condition of the step S96 is satisfied (“YES”), proceeds to the step S97. Otherwise (“NO”), proceeds to the step S99.

In the step S97, the time for determining an empty error is set to 1500 ms, and then proceeds to the step S98. In the step S98, the hopper 40 (rotary disc 111) is rotated in a clockwise rotation direction, and then proceeds to the step S101.

In the step S99, the time for determining an empty error is set to 500 ms, and then proceeds to the step S100. In the step S100, the hopper 40 (rotary disc 111) is rotated in a counterclockwise rotation direction, and then proceeds to the step S101. In the step S101, the error display data is cleared, and then proceeds to the step S76 or the step S82 of FIG. 15.

After the step S100 is performed, but before the condition of the step S73 or the step S79 (FIG. 15) is satisfied (“YES”), i.e., even while the hopper 40 (rotary disc 111) is rotating in a counterclockwise rotation direction, an operation of the coin passing switch is checked (the step S77) (i.e., the coin detection units 40Sa and 40Sb detects a coin being payout). Therefore, the game machine can determine more precisely the number of coins paid out.

In the following, an error processing will be described in detail with reference to FIG. 17.

First, the CPU 31 sets an error flag based on error display data (i.e., empty data or jam data) (step S111), and then proceeds to the step S112. The error flag includes information to identify a type of an error. In the step S112, error information (a type of an error) to be transmitted to the sub-control circuit 72 is stored, and then proceeds to the step S113. The sub-control circuit 72 receives the error information to notify an occurrence of an error through the LCD display device 5 and the loud speakers 21L and 21R.

In the step S113, it is determined whether a jam error has occurred based on the error flag. If the condition of the step S113 is satisfied (“YES”), proceeds to the step S114. Otherwise (“NO”)(i.e., if an empty error has occurred), proceeds to the step S116.

In the step S114, an occurrence of an error (hopper jammed) is notified through the information display unit 18, and then proceeds to the step S115. In the step S115, it is checked whether the coin passing switch is ON. If the condition of the step S115 is not satisfied (“NO”), i.e., if a coin causing a jam error has been removed, proceeds to the step S117.

In the step S116, an occurrence of an error (hopper empty) is notified through the information display unit 18, and then proceeds to the step S117. In the step S117, it is checked whether the error reset switch 68 is ON. For example, in case an empty error has occurred, it is checked whether an operator of an arcade has refilled the hopper with coins and manipulated the error reset switch 68. If the condition of the step S117 is satisfied (“YES”), proceeds to the step S118.

In the step S118, an occurrence of an error is notified, and then proceeds to the step S119. In the step S119, the error flag is set to OFF, and then proceeds to the step S120. In the step S120, error clear information to be transmitted to the sub-control circuit 72 is stored, and then proceeds to the step S76 and the step S82 (FIG. 15). The sub-control circuit 72 receives the error clear information to complete the notification of an error through the LCD display device 5 and the loud speakers 21L and 21R.

While the present invention has been shown and described with respect to a preferred embodiment, the scope of the invention is not limited thereto.

In the embodiment, the initial value of the hopper reverse rotation counter is set to 3, but not limited thereto. For example, the initial value of the hopper reverse rotation counter may be set to 1, 5 or any other value. Further, the initial value of the hopper reverse rotation counter may be set to an even number.

Further, in case a jam error has occurred, the rotary disc 111 may be controlled not to rotate in a counterclockwise rotation direction. In particular, in case a jam error has occurred, the value of the hopper reverse rotation counter may be set to 1.

Furthermore, the time for determining a jam error and the time for determining an empty error (i.e., time for rotating continuously the rotary disc 111 in one rotation direction) is not limited to the value described in the embodiment, but may be set to any other value.

Still further, a means for setting the initial value of the hopper reverse rotation counter, the time for determining a jam error or the time for determining an empty error (a mode of operation (e.g., a rotation direction and rotation time) of the motor 121 for checking an error or removing an error), which is manipulated by an operation of an arcade, may be installed, e.g., in the power source box 66.

The values of these counters may define the number of trials for removing an error, time required for removing an error, or time for determining an error. Therefore, if an operator of an arcade can set the values of the counters, it is possible to set desired values thereto to manage a game media payout device.

Meanwhile, although the coin detection units are implemented by employing photo-sensors of reflection type in the embodiment, but not limited thereto. For example, the coin detection units may be implemented by employing photo-sensors of transparent type or any other type.

The effects described above with respect to the preferred embodiment shows only those obtained from the best mode of the embodiment in accordance with present invention. Therefore, the effects of the present invention are not limited thereto.

What is claimed is:

1. A game media payout device for use in a game machine, comprising:
a container for accommodating a multiplicity of game media;
a rotary disc disposed on a bottom of the container;
a plurality of openings arranged in a circumference of the rotary disc, each of the openings having a size for accommodating the game medium;
a payout control means for generating a payout instruction signal for paying out a predetermined number of game media;
a driving means, which is configured to drive the rotary disc in a clockwise direction or a counterclockwise direction, for driving the rotary disc in a clockwise direction in response to the payout instruction signal and driving the rotary disc in a counterclockwise direction if a predetermined condition is satisfied;
a game media receiving plate for receiving game media dropped from the container and caught in the openings;
a game media feeding guide plate, which is installed to be integrated into a rear surface of the rotary disc, for guiding the game media received by the game media receiving plate in a direction radially away from a center of the rotary disc in response to the rotation of the rotary disc in a clockwise direction;
a fixed roller disposed at a game media outlet, for changing a moving direction of the game media toward the game media outlet;
a displaceable roller disposed at the game media outlet, which is displaced by the movements of the game media being ejected by the game media feeding guide plate to eject the game media to the game media outlet;
a detecting means disposed at the game media outlet, for detecting the game media being ejected to the game media outlet by the displaceable roller; and
a monitoring means for monitoring an operation of the detecting means even in a situation where the driving means drives the rotation of the rotary disc in a counterclockwise direction in response to the payout instruction signal.

2. The game media payout device of claim 1, wherein the predetermined condition is satisfied by either when the detecting means does not detect any game media being payout even if the driving means drives the rotary disc in a clockwise direction during predetermined time; or when the detecting means detects continuously game media being paid out during a predetermined time after the payout instruction signal is generated.
